(19) United States
(12) Patent Application Publication
(10) Pub. No.: US 2015/0269317 A1
(43) Pub. Date: Sep. 24, 2015

(54) METHODS AND APPARATUS FOR GENERATING AND EVALUATING MODIFIED DATA STRUCTURES

(71) Applicants: Cameron Marcum, Chandler, AZ (US); Joshua Leslie, Chandler, AZ (US)

(72) Inventors: Cameron Marcum, Chandler, AZ (US); Joshua Leslie, Chandler, AZ (US)

(21) Appl. No.: 14/218,734

(22) Filed: Mar. 18, 2014

(51) Int. Cl. G06F 19/00; G06Q 50/24

(52) U.S. Cl. CPC G06F 19/322; G06Q 50/24

(57) ABSTRACT

Apparatus and methods for generating and evaluating modified data structures. In one exemplary embodiment, a client device is used to collect raw data, which may include audio/video recordings. The raw data is then processed to include metadata describing various portions of the raw data. Portions of the raw data and the metadata are packaged together to form data records which are transmitted to an evaluation entity. In one particular implementation, the segments of a documented patient encounter are identified and modified data structures are generated therefrom for evaluation at a third-party entity. The modified data structures in this instance comprise the segments of the patient encounter as well as healthcare provider notes and one or more uniform healthcare service codes (such as CPT codes, HCPCS codes, ICD codes, etc.). According to this embodiment, the formatted records are transmitted to e.g., an insurance entity for evaluation thereat.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Disclosure

The present disclosure relates in one aspect to improved methods and apparatus for generating and evaluating modified data structures. In one exemplary health-care based implementation, a system which identifies data segments within a documented patient encounter and generates modified data structures therefrom for evaluation at a third-party entity is disclosed.

2. Description of Related Technology

Medical, surgical, and diagnostic services are assigned uniform identifiers by the American Medical Association (AMA) called Current Procedural Terminology (CPT) codes. Physicians, patients, insurance providers, etc. utilize CPT® codes for uniform communication of information regarding medical services. Today, the CPT is the industry standard for all medical coding purposes. However, other coding systems may also be implemented with equal success. For example, numeric code values for various healthcare services may be represented by Healthcare Common Procedure Coding System (HCPCS) codes, International Classification of Diseases (ICD) codes, or others.

Each of the foregoing healthcare services coding systems (CPT, HCPCS, and/or ICD) represent a comprehensive list of thousands of healthcare services. The foregoing code sets are utilized to e.g., request payments (such as from insurance companies or from patients), request or explain coverage/benefits under an insurance plan, substantiate drug prescriptions, etc.

Federal and State laws require the correct determination and application of healthcare services codes (such as CPT codes, HCPCS codes, ICD codes, etc.) for each patient encounter which is billed to a patient or an insurance agency in order to avoid fraud, waste, and/or abuse of the healthcare financing system, and incorrect code application may result in fines or sanctions against the offending healthcare provider. Specifically, a healthcare provider may not “overcode” or “undercode” the services provided.

Currently, a variety of methods exist to assist physicians in documenting and reporting healthcare services using CPT or other healthcare services codes. For example, paper-based forms for standardization may be utilized. Such forms require a physician to fill-in blanks, check boxes, type or write notes, and/or determine an appropriate code to apply. However, these forms do little to streamline the already complicated process.

Further, certain computer-based systems may recommend a CPT (or other) code based on physician-entered answers to questions regarding an interview/encounter and may generate proper documentation, including billing forms. However, such systems are ineffective at providing a fully automated system that extends beyond the identification and application of the appropriate CPT code.

In addition, certain supporting documentation (including e.g., the physician's notes) may be provided to evidence a diagnosis, treatment plan, service provided, etc. to the insurance agency. For example, a physician or other healthcare provider may be required to disclose medical information for the purpose of obtaining payment from an insurance company. Ideally, only the minimum amount of protected health information (PHI) should be provided for this purpose. For example, laboratory results should not be provided to an insurance agency, as these are not required for billing and/or determination of coverage. Current mechanisms for providing such evidence include oral or written disclosure from a physician (or other healthcare service provider's) notes or memory, and are often ineffectual.

Accordingly, there is a salient need for improved apparatus and methods which provide efficient and reliable solutions for collection and organization of information, such as for example that obtained during a patient interview. Such improved systems and methods would further enable a descriptor (e.g., CPT code in the health care context) to be accurately applied to the interview content.

Ideally, the improved apparatus and methods would further aggregate the applicable descriptor(s) (e.g., CPT codes) with text and evidence (such as audio and/or video evidence relied upon by the healthcare provider in making healthcare diagnosis and decisions).

### SUMMARY

The present disclosure satisfies the aforementioned needs by providing, inter alia, methods and apparatus for identifying data segments, such as within a documented patient encounter, and generating a modified data structure comprising information relating thereto.

In a first aspect, a method for generating data records is disclosed. In one embodiment, the method comprises: (i) collecting a plurality of data; (ii) identifying one or more regions of interest within said plurality of data; (iii) generating metadata describing said one or more regions of interest within said plurality of data; and (iv) packaging at least portions of said plurality of data comprising said one or more regions of interest with said metadata descriptive thereof.

In another variant, the method is configured to generate healthcare service data records, and comprises: (i) creating a media recording of a healthcare session; (ii) identifying one or more aspects of interest within said media recording; (iii) applying a timestamp to each of said one or more aspects of interest; (iv) for each of said one or more aspects of interest, applying an alpha-numeric code descriptive thereof; and (v) generating a plurality of data records, of said plurality of data records comprising at least a portion of said media recording, said timestamp, and said alpha-numeric code.

In a second aspect, a computer readable apparatus comprising a plurality of computer executable instructions is disclosed. In one embodiment, the plurality of computer executable instructions which are configured to, when executed, cause a client electronic device to: (i) collect a plurality of data; (ii) identify at least one subset of data within said plurality of data; (iii) generate metadata describing said at least one subset within said plurality of data; and (iv) package at least portions of said plurality of data comprising said at least one subset with said metadata descriptive thereof.

In another embodiment, the plurality of computer executable instructions are configured to, when executed, cause a client electronic device to: (i) create a media recording of a healthcare session; (ii) identify one or more aspects of interest within said media recording; (iii) apply a timestamp to each of said one or more aspects of interest; (iv) for each of said one or more aspects of interest, apply an alpha-numeric code descriptive thereof; and (v) generate a plurality of data records for transmission to an evaluation entity, said plurality of data records comprising at least a portion of said media recording, said timestamp, and said alpha-numeric code.

In a third aspect, a user apparatus configured to generate a plurality of data records is disclosed. In one embodiment, the apparatus comprises: (i) a first interface configured to receive a plurality of raw data; (ii) a storage apparatus; and (iii) a processor configured to run a record generation application thereon. In one variant, the record generation application comprises a plurality of instructions which are configured to when executed, (i) collect said plurality of raw data; (ii) identify one or more regions of interest within said plurality of raw data; (iii) generate metadata describing said one or more regions of interest within said plurality of raw data; and (iv) package at least portions of said plurality of raw data comprising said one or more regions of interest with said metadata descriptive thereof.

In another variant, the data records comprise healthcare service records and the record generation application comprises a plurality of instructions which are configured to when executed, comprises: (i) create a media recording of a healthcare session; (ii) identify one or more aspects of interest within said media recording; (iii) apply a timestamp to each of said one or more aspects of interest; (iv) for each of said one or more aspects of interest, apply an alpha-numeric code descriptive thereof; (v) generate a plurality of data records, of said plurality of data records comprising at least a portion of said media recording, said timestamp, and said alpha-numeric code, and (vi) cause transmission of said plurality of data records to an evaluation entity.

In a fourth aspect, a host server is disclosed. In one embodiment, raw data is collected at a client apparatus and transmitted to the host server, which is configured to package the raw data into a plurality of data records and transmit the data records to an evaluation entity.

In a fifth aspect, an evaluation entity is disclosed. In one embodiment, modified records are received at the evaluation entity, and the evaluation entity uses information contained in the records to validate the performance of a service therein.

### BRIEF DESCRIPTION OF THE DRAWINGS

FIG. 1a is a block diagram illustrating an exemplary embodiment of a data collection and evaluation network according to the present disclosure.

FIG. 1b is a block diagram illustrating another embodiment of an exemplary data collection and evaluation network according to the present disclosure.

FIG. 2 is a block diagram illustrating an exemplary client device according to one embodiment of the present disclosure.

FIG. 3 is a block diagram illustrating an exemplary host device according to one embodiment of the present disclosure.

FIGS. 4a-4b are graphical representations of an exemplary interface for enabling a user of the record generation application to utilize the features disclosed herein.

FIG. 5 is a logical flow diagram illustrating a one embodiment of a generalized method of information collection and record generation according to the present disclosure.

FIG. 6 is a logical flow diagram illustrating one specific implementation of a method of information collection and record generation according to the present disclosure.

FIG. 7 is a logical flow diagram illustrating an exemplary method for creating an account according to the present disclosure.

### DESCRIPTION

Reference is now made to the drawings listed above, wherein like numerals refer to like parts throughout.

As used herein, the term “application” refers generally to a unit of executable software that implements theme-based functionality The themes of applications vary broadly across any number of disciplines and functions (such as e-commerce transactions, shipping transactions, entertainment, calculator, Internet access, etc.), and one application may have more than one theme. The unit of executable software generally runs in a predetermined environment; for example and without limitation, the unit could comprise a downloadable Java XIet™ that runs within the JavaTV™ environment.

As used herein, the term “client device” includes, but is not limited to, personal computers (PCs), whether desktop, laptop, tablet, or otherwise, personal digital assistants (PDAs), cellular or “smart” phones such as the Apple iPhone, handheld computers, J2ME equipped devices, personal media devices, set-top boxes, or literally any other device capable of interchanging data with a network. Such devices may interface using wired or optical fiber mechanisms such as an IEEE Std. 802.3 Ethernet interface, Digital Subscriber Line (DSL), DOCSIS modem, hybrid fiber-coax (HFC) cable, FireWire (IEEE Std. 1394), Thunderbolt™, or alternatively via wireless mechanisms and protocols such as LTE/LTE-A, 3GPP/3GPP2, Bluetooth™, IrDA interface, IEEE Std. 802.11, UWB (e.g., IEEE-Std. 802.15 or similar), WiMAX (802.16), Wireless Application Protocol (WAP), GPRS, GSM, or any other of myriad data communication systems and protocols well known to those of skill in the communications arts.

As used herein, the term “computer program” is meant to include any sequence of human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “database” refers generally to one or more tangible or virtual data storage locations, which may or may not be physically co-located with each other or other system components.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the term “display” means any type of device adapted to display information, including without limitation CRTs, LCDs, TFTs, plasma displays, LEDs (e.g., OLEDs), and fluorescent devices.

As used herein, the term “memory” or “storage” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to data or communications networks regardless of type, including without limitation, LANs, WANs, intranets, internets, the Internet, cable systems, telecommunications networks, satellite networks, and Virtual Private Networks (VPNs), or collections or combinations thereof, whether based on wired, wireless, or matter wave modalities. Such networks may utilize literally any physical architectures and topologies (e.g. ATM, IEEE-802.3, X.25, Token Ring, SONET, 3G/3GPP/UMTS, 4G/LTE/LTE-A, 802.11, 802.16, 802.15, Hybrid fiber-coax (HFC), etc.) and protocols (e.g., TCP/IP, HTTP, FTP, WAP, GPRS, RTP/RTCP, etc.), or combinations of the foregoing.

As used herein, the term “server” refers to any computerized component, system or entity regardless of form which is adapted to provide data, files, applications, content, or other services to one or more other devices or entities on a computer network.

As used herein, the term “speech recognition” refers to any methodology or technique by which human or other speech can be interpreted and converted to an electronic or data format or signals related thereto. It will be recognized that any number of different forms of spectral analysis (such as MFCC (Mel Frequency Cepstral Coefficients) or cochlea modeling, may be used. Phoneme/word recognition, if used, may be based on HMM (hidden Markov modeling), although other processes such as, without limitation, DTW (Dynamic Time Warping) or NNs (Neural Networks) may be used. Myriad speech recognition systems and algorithms are available and contemplated, all considered within the scope of the disclosure provide herein.

As used herein, the terms “storage device” and “mass storage device” refer, without limitation, to devices capable of storing comparatively large amounts of digital data, such as e.g., HDDs (e.g., SATA, PATA/IDE/UDMA, SCSI), solid state devices (e.g., SSDs), and optical mass storage.

As used herein, the term “user interface” refers to, without limitation, any visual, graphical, tactile, audible, sensory, or other means of providing information to and/or receiving information from a user or other entity.

### Overview—

The present disclosure relates in one aspect to methods and apparatus for generating and evaluating modified data structures. In one particular implementation, the system identifies data segments within a documented patient encounter; modified data structures are generated therefrom for evaluation via a third party or other entity or process.

The exemplary apparatus and methods utilize e.g., a client device to collect raw data. The raw data may comprise for example audio and/or video recordings, including audio/video recordings of a patient and healthcare service provider session. The audio/video data may be provided using e.g., videotelephony, VOIP, or other services. The raw data is then processed to include metadata describing various portions or aspects of the raw data. In one specific implementation, the metadata further includes standardized alpha-numeric or other codes to describe the collected data. A computer program running on either a host device or the device which collected that data packages the raw data and the metadata to form data records. The packaged data records are then transmitted to an entity for evaluation or other use.

In the aforementioned specific implementation, the collected data comprises an audio and/or video recording of a patient and healthcare provider interaction. The recording is parsed into sections and healthcare provider notes are added. In addition, one or more uniform healthcare service codes (such as CPT codes, HCPCS codes, ICD codes, etc.) are also added. The raw data is then formatted into individual data records where metadata is attached to at least portions or clips of the raw data. According to this implementation, the formatted records are transmitted to e.g., an insurance entity for evaluation thereat.

Various apparatus and methods for providing the functionality are also disclosed.

### Description of Exemplary Embodiments—

It is noted that while the apparatus and methods of the present disclosure are described with respect to delivery of information regarding a healthcare services patient, certain aspects may be useful in other applications, including, without limitation, car repairs, home inspections, legal billing, technical support for electronic or computerized systems, web meetings/teleconferences, and other hourly billable work requiring proof or evidence of the assistance provided or work performed.

### Data Structure Generation and Evaluation Network Architecture—

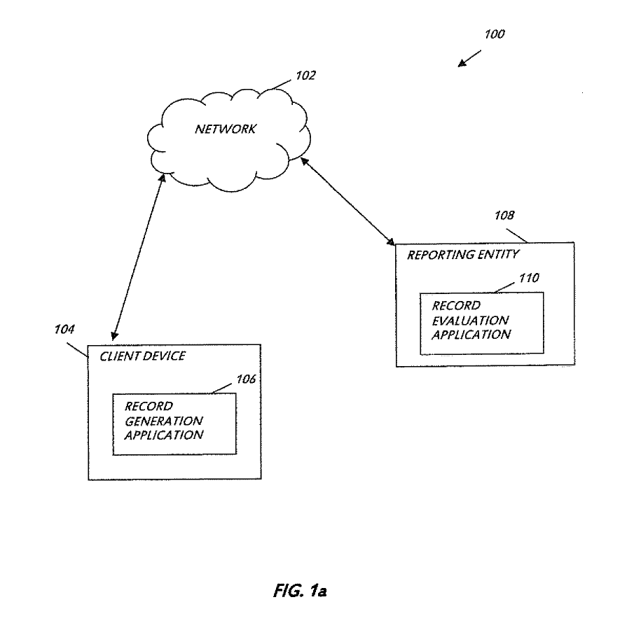

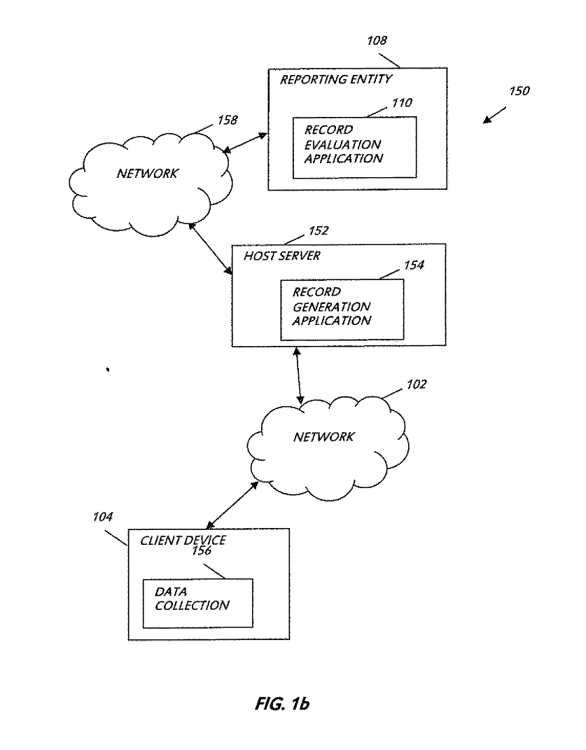

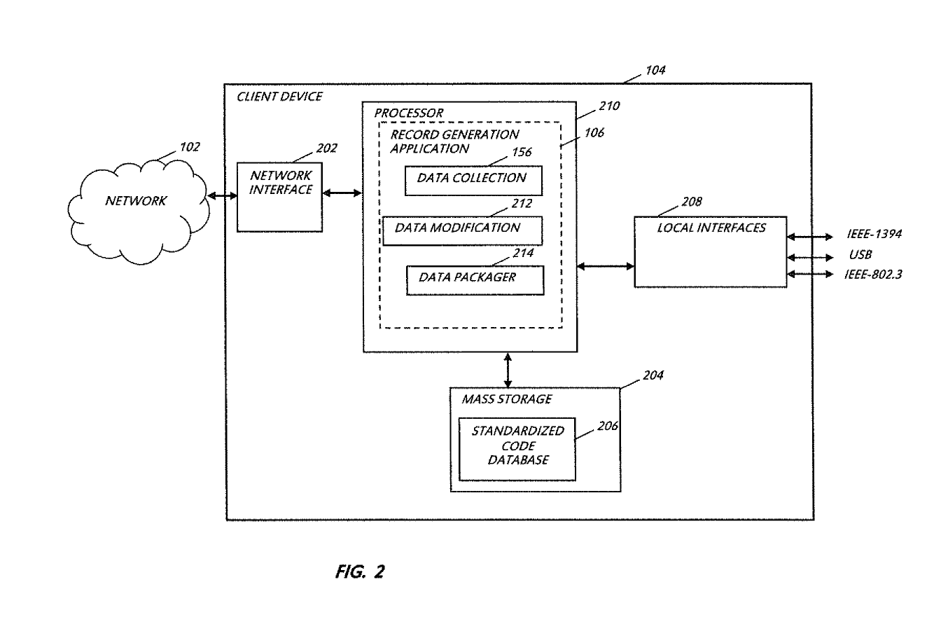

Referring now to FIG. 1a, an exemplary embodiment of a data collection and evaluation network 100 according to the present disclosure is illustrated. As shown, the network 100 generally comprises one or more client devices 104 in communication with a reporting entity 108 via a communications network 102. In one exemplary embodiment, the client device 104 is configured to run at least one record generation software application 106 thereon. As will be discussed in greater detail elsewhere herein, the software application 106 is configured to enable the client device to collect a plurality of data, modify the data to identify various points of interested therein, process the data to apply metadata thereto, generate a data record comprising the metadata and a portion of the data, and transmit the data record. In one variant, the metadata comprises a code and/or description of the various points of interest identified. Modified and packaged data records are transmitted to a reporting entity 108 via a network 102 connection thereto.

It is appreciated that the network 102 may be any type of network, including for example “ad hoc” networks (i.e., those without prescribed topology and/or membership, which can be readily joined and dissociated from) such as Wi-Fi or Bluetooth networks, more “fixed” types of networks (e.g., those based on IEEE 802.3 of the like), so-called “mesh” networks, combination networks, etc. Moreover, the network connection between the client device 104 and the reporting entity 108 may comprise e.g., a secure connection. Security of a connection between the device 104 and the reporting entity 108 may be ensured via any one of the well known mechanisms for securing data collection such as e.g., data encryption (such as PM), and/or at the protocol level (such as via SSL or TLS protocols and key exchange protocols). Authentication of a user and/or a particular device via entry of login credentials may also be utilized, as may other related techniques aimed at detecting or precluding surreptitious intrusion such as MIM (man-in-the-middle) detection means, CRC, one-way hash, etc.

The reporting entity 108 is in the illustrated embodiment a third-party entity which evaluates the modified data in order to make decisions relating to e.g., payment, or coverage (such as health or other insurance coverage). The reporting entity 108 is configured to run at least one record evaluation software application 110 thereon. It is via the software application 110 that data records are received and processed or evaluated (such as by an operator of the reporting entity 108); however, it will be further appreciated that the system may be wholly automated if desired (such as e.g., where an evaluation algorithm or process is used to evaluate the modified data and render decisions based thereon, and/or pass the evaluation on to another entity (pre-processing).

In one specific implementation, the reporting entity 108 may comprise a server associated to a health insurance company or service provider. According to this implementation, the client device 104 records audio/video data relating to a patient's healthcare services via the record generation application 106. The collected data is parsed (i.e., a data segment is created from the last identified portion to the present identified portion such that the data is segmented by event) and portions thereof are identified as pertaining to particular healthcare services to be provided, either automatically (e.g., via speech recognition derived from the live session, etc.) or by a user of the client device 104 (e.g., via user input to the application by way of a user interface such as a GUI, pull-down menu, speech input, etc.). The identified portions are then associated to standardized healthcare services codes, such as e.g., Current Procedural Terminology (CPT) codes (again this may occur automatically or via a user selection). Formatted data records are generated by associating an applicable standardized healthcare services code and other descriptive information (metadata) to a particular portion of an audio and/or video clip. The formatted data records are then transmitted to the insurance company or service provider server for evaluation via the record evaluation application 110.

In the exemplary implementation, the record evaluation application 110 enables, inter alia, a user or operator thereof (or an autonomous or semi-autonomous process or algorithm) to review the healthcare services code (e.g., CPT code), the associated data and the audio/video clip to e.g., to determine whether a particular procedure is within a patient's insurance plan coverage, such as for the purpose of determining whether to pay a healthcare provider for services rendered, whether a prescription medication or treatment plan is substantiated or appropriate (e.g., whether the medication prescribed is authorized for payment, does not conflict with other medications prescribed to the patient, whether alternatives such as lower-cost generics are available, etc.).

Referring now to FIG. 1b, another embodiment of a data collection and evaluation network 150 according to the present disclosure is illustrated. As shown, the network 150 generally comprises one or more client devices 104 in communication with a host server 152 (or multiple servers, such as in a “farm” or other configuration) via a first communications network 102. The host server 152 is, in turn, in communication with a reporting entity 108 via a second communications network 158. The networks 102, 158 may be homogeneous, heterogeneous, aggregates of constituent networks (e.g., “daisy-chained”), meshed, or any other configuration/topology as desired.

The illustrated example is specifically configured to enable the client to comprise a so-called “slim” or “thin” device. In other words, the client device 104 in this embodiment need not perform any data modification, identification, formatting, and/or packaging tasks. Rather, the client device 104 is merely configured to collect raw data via the data collection application 156 running thereon, and transmit the data to the host server 152 or other processing entity. For example, the data collection application 156 may enable the client device 104 to capture raw (or unaltered) video and/or audio data. The audio/video data may be streamed directly to the host server 152, or may be provided either automatically or manually via a push and/or pull mechanism, or yet other modality.

According to this implementation, the host server 152 performs all of the data modification, identification, formatting, and packaging tasks via a record generation application 154 operative thereon. The record generation application 154 enables the host device to modify the data to, among other things, identify various points of interest therein, process the data to apply one or more pieces of metadata thereto, generate a data record (in one embodiment, comprising the metadata and a portion of the data), and transmit the data record to the reporting entity 108. In one variant, the metadata comprises a code and/or description of the various points of interest identified. Such code and/or description may be human readable and intelligible (i.e., a human can read it and understand is its meaning), human readable but not intelligible (i.e., a human can read it but not necessarily appreciate the meaning of what was read), non-human readable (e.g., machine readable, such as a bar code, optical character, etc.), or otherwise, and any permutations of the foregoing.

In yet another variant, the host server 152 provides an interface accessible by a user of the client device 104, whereby the user can manually modify the data records being generated. For example, the host server 152 may provide a web-based interface accessible via the user's client device 104 which enables the user to view the data records as they are being generated (or thereafter) and add notes, descriptors, embed other content, etc.

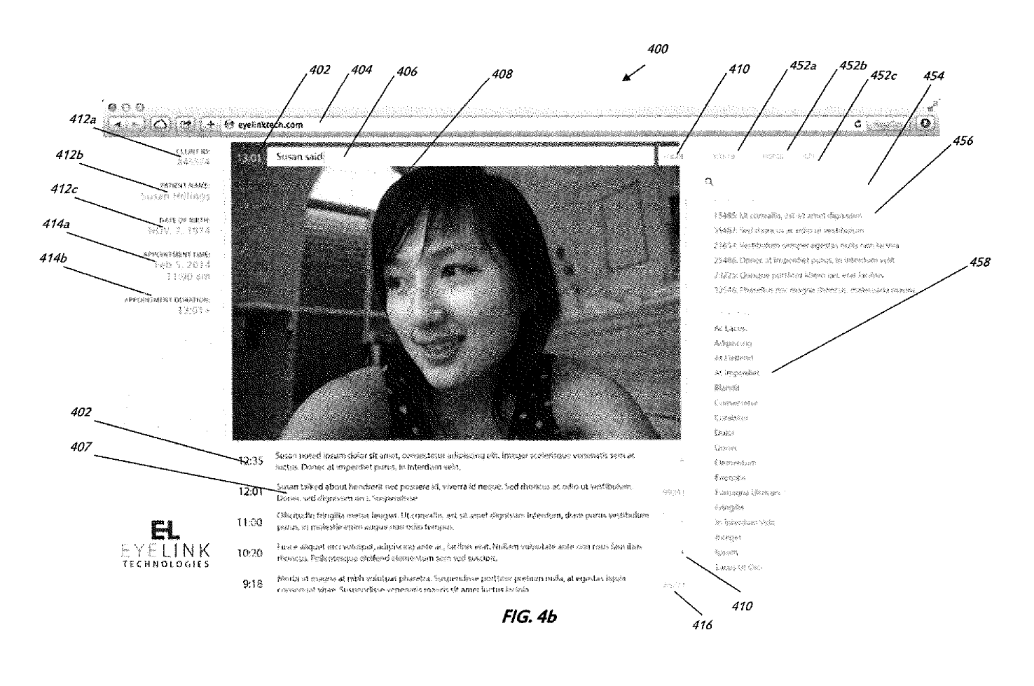

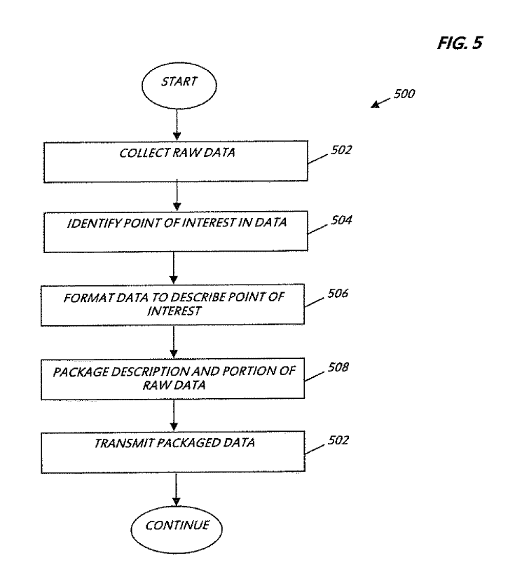

In yet another embodiment, the user himself may be charged with certain portions of the data formatting (for example selecting a data code to match the data which has been collected). An exemplary user interface is discussed in greater detail below with respect to FIGS. 4a and 4b.

As discussed above with respect to the reporting entity 108 of FIG. 1a, the reporting entity 108 of FIG. 1b is configured to run a record evaluation application 110 thereon, which enables a user or operator thereof to evaluate the data records provided thereto.

In one specific implementation, the data collection and evaluation network 150 may be utilized during the provision of healthcare services. For example, the client device 104 may record audio/video data relating to a patient's healthcare services via the data collection application 156. Other collection apparatus may be used as well, such as those of the service provider, a third party, etc. The data collected therefrom is transmitted (via network 102) to the host server 152. The host server 152 may automatically parse the data into portions by healthcare service event, by auditory cue, by time segments, etc., or otherwise enable a user at the host server or at the client device to do so via identification of events in a GUI and a chopping of data at each indicated event. The identified portions are then associated to standardized healthcare services codes, such as e.g., Current Procedural Terminology (CPT) codes; this may occur automatically by the record generation application 154, or manually by a user at the host server or at the client device, or combinations thereof. The standardized healthcare services codes and the descriptions (or other relevant data) are formatted to portions or clips of the audio/video data associated therewith, then transmitted to the insurance company server (e.g., the reporting entity 108) for evaluation by a user or operator threat.

A more detailed discussion of an exemplary client device 104 and an exemplary host server 152 are provided below.

### Exemplary Apparatus

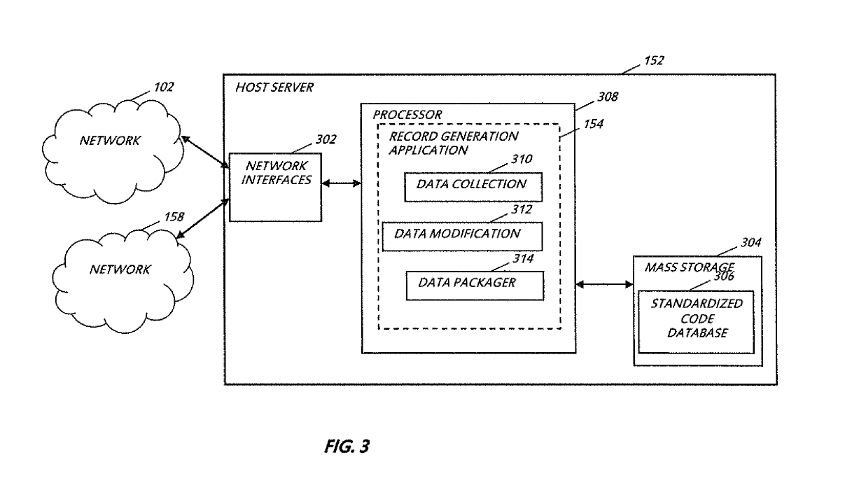

Referring now to FIG. 2, an exemplary client device 104 for use in conjunction with the data collection and evaluation network 100 of FIG. 1a is illustrated. As shown, the client device 104 generally comprises a network interface 202, a processor 210 and associated memory 204, and one or more backend interfaces 208.

The network interface 202 enables communication of the client device 104 to other entities (e.g., third party entities) via a network 102, which may be of any variety of types and/or topologies. In one embodiment, the network 102 comprises an internetwork (e.g., one with Internet connectivity) with communication thereto occurring via well-known packet-based Internet Protocol (IP). In However, other networks may be utilized with equal success. It is further appreciated that the network interface 202 may be adapted to encrypt or otherwise secure data prior to transfer to the reporting entity 108, such as via a VPN tunnel or other such mechanism. For example, the interface 202 may apply public/private key encryption, or other well-known encryption scheme.

The processor 210 in the embodiment of FIG. 2 is configured to run the record generation application 106 thereon. In the illustrated embodiment, the record generation application 106 comprises at least a data collection module 156, a data modification module 212, and a data packager module 214, which cooperate to provide the desired functionality of the application.

The data collection module 156 is configured to capture raw data. In one embodiment, the data collection module 156 may work in conjunction with one of the local interfaces 208 to capture the data. For example, one of the local interfaces 208 of the client device 104 may comprise a module configured to record audio and/or video, such as via a camera (e.g., CMOS or CCD) and associated microphone. Alternatively, the client device 104 may merely interface with a separate device intended to record audio and/or video and transmit the data to the client 104 via e.g., USB, DisplayPort, Thunderbolt, or IEEE 1394 (Fire Wire), or other wired or wireless connection thereto (including e.g., Bluetooth, Wi-Fi, NFC, etc.). Additionally, raw data may include text, which has been entered using a keyboard or other input device, or a scanned or photographed image of handwritten, or other text to which optical character recognition (OCR) has been applied. Data may be entered, altered, etc. via a keyboard or other apparatus/input device, it is appreciated that the backend interface 208 may include a wired or wireless connection thereto. The exemplary data collection module 156 may be run independently of the remaining modules of the record generation application 106, as will be discussed in further detail elsewhere herein.

The data modification module 212 is configured to enable a user to modify raw data after it has been collected. As noted elsewhere herein, the modification to the raw data may include portioning the data into smaller segments or clips (which may or may not be contiguous with one another), and generating descriptive metadata or other data intended to describe the segments of the raw data. For example, the metadata may comprise information entered by a user of the client device 104 which is intended to summarize or give a synopsis of a portion of the raw data, while other ostensibly useless portions of the raw data are discarded or not annotated. In the instance the collected data comprises audio/video data, the metadata may comprise a user-entered description of a portion or clip of the audio/video segment. The user may enter the metadata using a keyboard, mouse and display all connected to the client device via the aforementioned backend interfaces 208. In another variant, some or all of the metadata relating to a particular portion of the raw data may be applied automatically.

A standardized code database 206 is provided which lists a plurality of uniform codes in the form of e.g., alpha-numeric characters, which are intended to represent certain data types. In the healthcare services example noted elsewhere herein, the standardized code database 206 may include a listing of all Current Procedural Terminology (CPT), Healthcare Common Procedure Coding System (HCPCS), International Classification of Diseases (ICD), International Classification of Functioning, Disability and Health (ICF), Diagnosis Related Groups (DRG), National Drug Codes (NDC), Code on Dental Procedures and Nomenclature (CDT), and/or DSM-V codes for Psychiatric Illnesses and the corresponding healthcare service associated to each. For example, a CPT code 702020 may be listed as associated with a single view radiologic examination of the cervical spine. Other standardized coding systems may be utilized as well.

In one embodiment, the user may modify segments of the raw data to add a standardized code thereto via the data modification module 212. For example, a user interface (as will be discussed elsewhere herein) may display a listing of the various coding systems, which once selected enable searching and application of an appropriate alpha-numeric code. In another embodiment, the data modification module 212 may be configured to utilize information obtained from the raw data in order to apply a standardized code automatically (i.e., without the intervention of a user). According to this embodiment, the system may further comprise speech recognition technology which is configured to recognize patterns, words, phrases, and/or combinations thereof as being associated to a particular standardized code. For example, the raw data may comprise a patient or healthcare service provider stating that an abdominal ultrasound is being performed. Accordingly, the data modification module 212 will use this statement to apply the CPT code of 76700 (or other applicable code and reference number). In an alternative embodiment, a combination of user entered and automatically generated standardized code application may be utilized. For example, the system may use speech recognition to understand that an ultrasound is being performed, however this recognition triggers the delivery of a list or pull down menu of healthcare services related to an ultrasound (e.g., abdominal ultrasound, 4D ultrasound, thyroid ultrasound, etc.). The user of the client device 104 may then select the appropriate CPT (or other) code.

In another variant, apparatus present at the session may be used to cue or provide inputs as to the function(s) or services being performed. For example, many doctor's offices have patient treatment or interview rooms with desktop computers, or local terminals, with audio generation capability. In one such implementation, the attending physician or clinician inputs information into the terminal/computer (which may be as simple as checking an onscreen box) prior to instituting the service. The terminal (e.g., remote networked server servicing the terminal) then causes the local terminal to emit an audible tone or sequence that uniquely identifies what service is being provided, thereby aiding subsequent automatic identification by e.g., algorithmic analysis of the audio portion of the signal, somewhat akin to well known prior art DTMF signaling. It will be appreciated that other forms of signaling may be used, including without limitation RF wireless, IR, optical, etc. This approach obviates the use of speech recognition or other such analysis, which may be prone to the individual peculiarities of speech, ambient noise, etc.

The data packager module 214 is configured to cause portions of the data and the metadata relating thereto to be packaged as a single data record. In one embodiment, the data records are generated automatically by the packager module 214. Alternatively, the user of the client device 104 may be provided with a means (such as via a user interface as discussed below) for manually creating clips from the raw data and packaging particular metadata with the clips. The data packager 214 may further provide the aforementioned encryption or other mechanisms for ensuring security of data transmitted over the network 102.

As noted above, the data collection module 156, data modification module 212, and data packager module 214 may be provided via a user interface to the user of the client device 104; an exemplary user interface is illustrated in FIGS. 4a-4b discussed elsewhere herein.

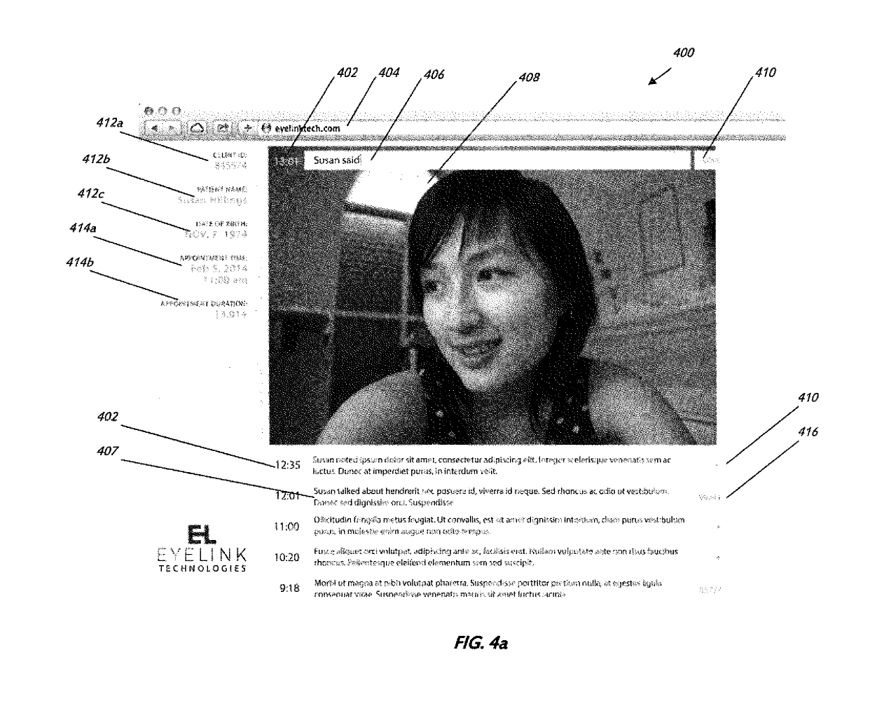

An exemplary host server 152 for use in conjunction with the data collection and evaluation network 150 of FIG. 1b is illustrated in FIG. 3. It is noted that in the architecture of FIG. 1b a “slim” or thin client device is utilized which performs only the initial raw data collection (via a data collection module 156 as described above) and transmits the raw data to the host server 152. The necessary functionality for performing data collection (from the client device 104), modification and packaging is located at the host server 152 in this embodiment.

Hence, the host server 152 of FIG. 3 comprises similar features to the client device 104 of FIG. 2. Specifically, the host server 152 comprises a record generation application 154 comprising a data collection module 310, a data modification module 312, and a data packager module 314.

The data collection module 310 is configured to receive raw data captured at the client device 104. The data is received over the network interface 302 and may comprise e.g., audio/video recordings and/or text (entered using a keyboard or a scanned or photographed image of handwritten, or other text to which optical character recognition (OCR) has been applied). As noted above, a data collection module 156 is run independently on the client device 104 for data capture.

The data modification module 312 enables a user to modify raw data after it has been collected. Alternatively (or in addition), the data modification module 312 enables automatic modification to raw data (such as without requiring intervention by a user or operator at the host server 152). Modification to the raw data may include portioning the data into smaller segments or clips, and generating descriptive metadata or other data intended to describe the segments of the raw data. The partitioning and entry of descriptive metadata may be performed by an operator at the host server 152, or a user of the client device 104 (which access the host server 152 via a user interface as described elsewhere herein). The metadata may give a synopsis of a portion of the raw data, and/or may comprise a selection (either an automatic selection or a manual selection) of a standardized code from a standardized code database 306.

The standardized code database 306, as discussed above with respect to that of the client device 104 in FIG. 2, comprises a database listing a plurality of uniform codes and the data types which they are intended to represent. In the healthcare services example discussed previously, the standardized code database 306 may include a listing of all CPT, HCPCS, ICD, ICF, DRG, NDC, CDT, and/or DSM-V codes and the corresponding healthcare service associated to each. Other standardized coding systems may be utilized as well.

In one embodiment, the user may access the host server 152 and modify segments of the raw data to add a standardized code thereto via the data modification module 312, such as via a user interface accessed either at the host server 152 or accessed by a so-called “thin” client device 104 in communication with the server 152. The user may select from a pull-down menu of available standardized codes. Alternatively, the data modification module 312 may be configured to utilize information obtained from the raw data in order to apply a standardized code automatically (i.e., without the intervention of a user, or with minimal user intervention, such as by limiting choices) based on recognized patterns, words, phrases, etc. and using a speech recognition technology.

The data packager module 314 enables packaging of portions of the data and the metadata relating thereto into a single data record. Packaging may occur automatically by the packager module 314, or alternatively the user of the client device 104 may be provided with a means (such as via a user interface as discussed below) for manually creating clips from the raw data and packaging particular metadata with the clips.

Packaged data records are then transmitting to a reporting entity 108 via a second network 158. In one variant the first network 102 and second network 158 comprise a single communications network, such as e.g., the Internet. Alternatively, various different networks with resultant communications protocols may be utilized. In this instance, the data collection module 310 may be configured to demodulate and decrypt received data, then the packager 314 re-encrypts the data records for transmission to the reporting entity 108.

As noted above with respect to the embodiment of FIG. 2 (where the record generation application 106 is run at the client device), the record generation application 154 run at the host server 152 may also be provided via a user interface. The user interface may be displayed to the user of the client device 104 via a display apparatus associated therewith via accessing the appropriate modules of the host server 152 by the client device 104; an exemplary user interface is illustrated in FIGS. 4a-4b.

### Exemplary User Interface

An exemplary user interface 400 for use in healthcare services is illustrated in the graphical representations of FIGS. 4a-4b.

As shown in the embodiment of FIGS. 4a-4b, a user may access the user interface 400 via entry of a web address or URL into a browser bar 404. This particular implementation is best suited for use with the network architecture of FIG. 1b. That is, in the instance that the host server 152 is configured to run the record generation application 154, and the client device 104 merely uploads raw data and access the application 154 run thereon, the access may be provided via a secure web link. In another alternative embodiment, the record generation application as discussed herein may be stored at the client device and accessed thereby via launch of the appropriate application, in such case entry of the URL into the browser bar 404 is unnecessary.

The user interface 400 provides, inter alia, information relating to a particular patient 412, such as e.g., a patient identification number 412a, a patient name 412b, a patient date of birth 412c, and/or other patient specific information. Additionally, the interface 400 provides appointment or session specific information 414 including e.g., the date and/or time of the appointment 414a, the duration of the appointment 414b, etc.

As shown in FIGS. 4a-4b, the interface 400 further displays via a display screen 408 the ongoing session. In one embodiment, the interface 400 provides a video display (and associated audio) using videotelephony, voice over IP (VOIP), or other video based communication. In the exemplary embodiment, the physician may be located at a first location, such as a doctor's office, while the patient is at a second location, such as his/her home. Alternatively, both the physician and patient may be in the same location, and a client device 104 comprises a mechanism to record audio/video data from the interaction and have the video output via the user interface 400 display screen 408. Additionally, while illustrated as a single display, it is appreciated that the display screen 408 may comprise two or more distinct portions. For example, audio/video of the physician may simultaneously be displayed, depending on the user's preference, using e.g., a so-called split screen.

A current entry bar 406 is provided in the exemplary user interface 400. As shown the current entry bar 406 enables a user of the system to input text relating to a currently occurring event within the patient-physician interaction. For example, the physician (or other healthcare provider) may specify or verify the words that the patient has said, or may otherwise enter notes, diagnosis, opinion, etc. relating to the interaction. The example text description illustrates the user entering the text “Susan said . . . ”, as relating to the current interaction.

The text description is timestamped 402 to enable a log of entries 407 to be created. In the illustrated embodiment, the log of entries is placed below the display screen 408 in time order (i.e., according to the timestamp 402 of each).

As the physician or other healthcare provider enters text in the current entry bar 406, he/she may also select an applicable code via the code addition icon 410. The selected or applied code designator 416 will appear as an icon added to the previous entry listings. Additionally, a user may add a code to any previous entry from the log 407 by selecting (such as by mouse click) the code addition icon 410.

Unique healthcare codes may be modified to an audio/video portion via utilization of the code addition icon 410 as illustrated in FIG. 4b. When a user selects (e.g., clicks) the code addition icon 410, a multi-layered display is provided. Various standardized healthcare code formats are each given individual selectable tabs; for example ICD-10 codes 452a, HCPCS codes 452b, and CPT 452c are illustrated as each having a selectable tab.

As shown, when the user selects one of the selectable tabs, he/she is given an opportunity to add a healthcare code to a current entry via searching for a particular healthcare topic in the search bar 454, selecting from among previously used healthcare codes in the recently used portion 456, and/or reviewing a list of healthcare topics listed alphabetically 458. Once the user has selected from among the available healthcare topics, the selected code is applied to the text description entered at the text bar 406.

It is appreciated that modification to include text is not mandatory, and may optionally be omitted. In this instance, a healthcare provider may merely identify a time during the session and associated healthcare code.

In another embodiment, as noted elsewhere herein, the application itself may apply a healthcare code based on information obtained from the audio/video data and/or the healthcare provider-entered text description (e.g., such as from speech that has been analyzed and recognized, audio or other cues, etc.).

In yet another alternative, the system may use this information to develop a list of suggested healthcare codes selectable by the user. In such systems, the user may identify in advance which standardized healthcare code type to be selected.

### Exemplary Methods

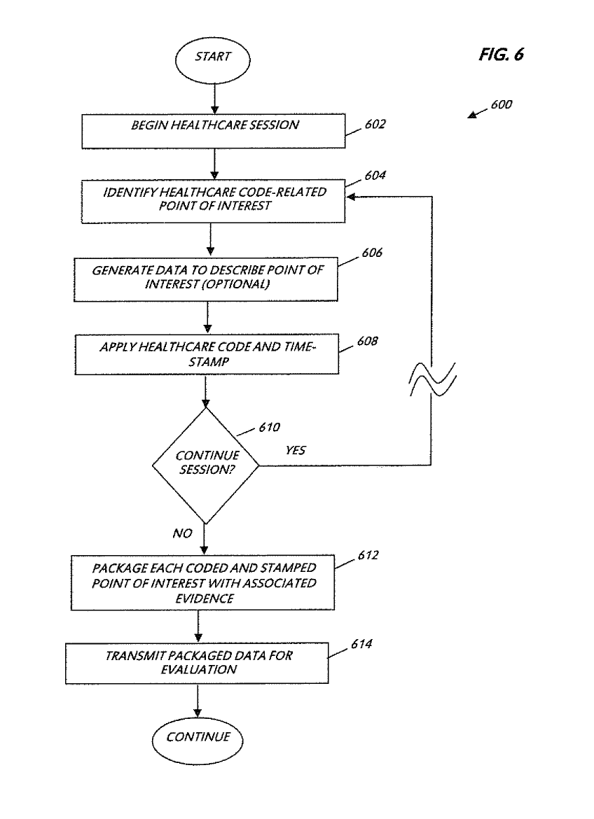

Referring now to FIG. 5, one embodiment of a generalized method of information collection and record generation for use with the present disclosure is illustrated. As shown the method 500 generally comprises collecting raw data at step 502. In one embodiment, the raw data comprises audio/video data; however other raw data types may be collected as well.

Next, per step 504, points of interest are identified within the data. The system may identify these points of interest automatically, or a user of the system may manually identify points of interest via a user interface. In one instance, the raw data is parsed at each identified point of interest.

It will be understood that as used herein, the term “point(s) of interest” refers, without limitation, to regions, portions, aspects, subsets, threads, and/or other attributes of the collected media, and is in no way limited to a discrete point in time or media space. For instance, in one variant, a “point of interest” corresponds to a section of time within the media relating to something of interest (e.g., where a physician and patient are discussing symptoms). In another variant, the “point of interest” corresponds to a logical thread pertaining to a patient's behavior during the session (e.g., repetitive twitch, agitation, etc.), which is not contained discretely within a given localized segment or point in time. Myriad other such “points of interest” will be recognized by those of ordinary skill when given the present disclosure. The points of interest may be further termed “chapters”, which are dropped in the exemplary API of FIGS. 4a-4b to the bottom of the screen as “notes” (such as the notes 407 of FIGS. 4a-4b).

At step 506, descriptive data is generated relating to the raw data at the identified points of interest. In one example, the descriptive data may comprise text which is added to the raw data via a user interface. The text may comprise a summary of the events depicted in the audio/video data for ease of reference. In another example, the descriptive data may comprise an alpha-numeric code from among a uniform set of alpha-numeric codes intended to identify certain types of interactions. As noted elsewhere herein, portions of the descriptive data may be added by a user or operator of the system, while certain other portions may be automatically added (such as based on information derived from the raw data or from user added descriptive data.

Next, per step 508, the metadata (descriptive data) of step 506 is packaged to a portion of the raw data to which it pertains. This step may occur manually, such as by the user of the system selecting certain portions of data and metadata to be joined, or automatically as noted above. The data packages are then transmitted to another entity for evaluation (step 510).

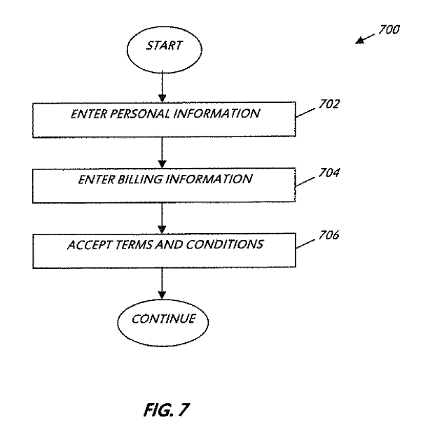

One specific implementation of a method fro information collection and record generation in a healthcare services industry is illustrated in FIG. 6. As shown, the method 600 begins when a healthcare session begins, at step 602.

Next, a healthcare code-related point of interest is encountered (step 604). In one embodiment, this point of interest may be identified automatically, such as via speech recognition and/or text recognition mechanisms designed to use information obtained from the ongoing session and to evaluate this information against a database of known healthcare codes. Alternatively, the user of the system (such as a healthcare service provider) may flag, mark, parse, or otherwise identify a point of interest. Identification of a point of interest may be further enabled by the healthcare service provider beginning to type a description and/or starting action to select a healthcare services code.

Per step 606, metadata is optionally generated relating to the point of interest. The metadata may include healthcare service provider-entered data (such as notes, descriptions, etc.) relating to the identified point of interest. One or more healthcare codes (whether selected by the healthcare provider, automatically by the system, or any combination of these) and a timestamp are also generated and applied (step 608). The metadata, healthcare code, and timestamp each relate to the specific identified point of interest.

The method 600 continues until the session reaches a conclusion (see step 610); at each identified point of interest (604) metadata and a timestamp are generated (606). Per step 612, each of the identified points of interest is used to generate a data package or record. The data packages include the metadata, the healthcare code, the timestamp, and a portion of the collected data (an audio/video clip). The packaged records are then transmitted (step 614) to a server or other entity associated with e.g., an insurance company. In this manner, the audio/video clip serves as evidence of the healthcare services performed, diagnosed, or intended as discussed above. In one implementation, the data package or record is generated in response to a termination of a session. For example, once a healthcare service provider has finished with notes, codes, and chapters, the healthcare service provider may submit the files to their electronic medical record (EMR) entity (if integrated) for sync. Upon sync, the notes and files will populate in the EMR entity under patients account for documentation along with codes, timestamps, and chapters of video file coordinating with the Medical codes and notes associated therewith. Furthermore, an email may be generated and sent out that allow for a specific period (e.g., days) to download the generated data package. The email may also be provided with a master uninterrupted copy of the session.

### Account Creation

In order for a user to take advantage of the herein disclosed apparatus and methods, in one embodiment, the user must register or sign-up. The user may be an individual, such as a patient, or professional, such as a healthcare provider, or an operator at an evaluation entity. However, as noted elsewhere herein, the present disclosure may be applied across various disciplines the foregoing healthcare embodiment being merely exemplary.

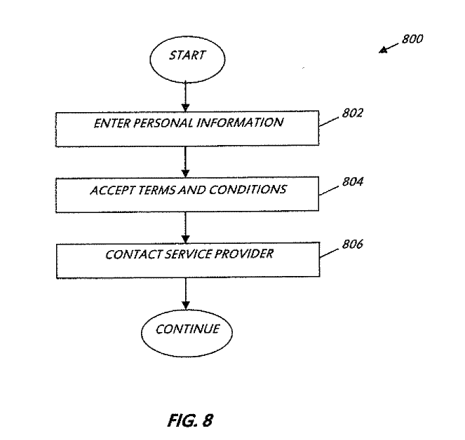

Referring now to FIG. 7, an exemplary method 700 of creating an account for an individual healthcare service provider, such as an individual doctor. By creating an account, the individual healthcare service provider may be linked to collected data records for which the healthcare service provider is responsible for modifying.

At step 702, the user enters personal information relating to the individual healthcare service provider. Such personal information includes identification information as first and last name, as well as a business entity (e.g., medical practice or company) to which the individual healthcare service provider is associated. The personal information may further comprise contact information such as telephone numbers (e.g., primary number and cell phone number), address (e.g., mailing address, email address) of the individual healthcare service provider.

One salient advantage of including detailed personal information is that the information may be used to group or otherwise manage a plurality of user accounts. For example, by including the business entity information, a master record may be generated for a particular business entity which groups all, or a subset, of healthcare service provider who are associated with a particular business entity. Furthermore, the personal information may be used for de-duplication purposes of records, such as electronics medical records, managing accounts, controlling internal support, customer service, and billing.

At step 704, the user enters billing information. In one embodiment, the billing information comprises a user's credit card information. Credit information typically includes a name of the authorized user of the credit card, the credit card number, expiration date, card security code (CVC), an a billing address linked to an account. In one implementation, if the account is linked to a master account, the user may agree to add a particular service provider to the master account for billing purposes. The agreement may be linked to terms and conditions such that the business entity may be charged per user based on agreed billing rates. In additional, failure of acceptance, or expiration, of the billing information may cause a temporary suspension of the account until a valid form of payment is entered.

At step 706, the user is prompted with terms and conditions for acceptance. In one embodiment the terms and conditions comprise various applicable legal conditions, rights, disclaimers, regulations (e.g., Health Insurance Portability and Accountability Act), statements regarding propriety information. A user who has not accepted the terms and conditions may be prevent from accessing portions, or the entirety, of the information collection and record generation system of the present disclosure as discussed herein.

At step 708, the user account is activated for use upon acceptance. In one embodiment, after activation, a user may be guided through a tutorial process of one or more services offered by the information collection and record generation system. A user may be able to decline the tutorial process which may be offered for later viewing, such as through a help functionality included in the user interface of the system. A system generated email may also be generated and sent to the email address as listed in the personal information section. The email may comprise a confirmation of the account creation. The email may additionally comprise an embedded link to perform any remaining account creation tasks such as account verification and setting the account password for logging in.

Upon logging in, the service provider of the account may access various services offered by the information collection and record generation system. For example, a service provider may be able “invite patients” to join sessions by sending a link, such as through email. A service provide may be provide a patient's account number to facilitate locate data records between the information collection and record generation system to other systems, such a electronic medical record systems or practice management.

Referring now to FIG. 8, is an exemplary method 800 for creating a patient account. In one embodiment, the account creation is triggered by a session invitation transmitted to a patient per an invitation request sent by a healthcare service provider. The invitation may be in the form of an electronic message transmitted to an address of a patient. In one implementation, the generated electronics message includes a link to begin the patient account creation process.

At step 802, a patient inputs personal information. The personal information may include a variety of identification information such as first and last name, contact information such as telephone numbers (e.g., primary number and cell phone number), address (e.g., mailing address, email address). In addition, the personal information may comprise a patient identification number. The patient identification may be auto-populated for the patient, for example in the instead where the requesting healthcare service provider included the information as part of the request. The patient may further be given an opportunity to include the patient identification number and/or edit the information.

One salient advantage of inputting the patient's personal information is that the information may be used to match records maintained by other systems, such as EMR systems, with the records generated by the information collection and record generation system.

At step 804, the patient will be prompted to accept terms and conditions associated with the information collection and record generation system. In one embodiment the terms and conditions comprise various applicable legal conditions, privacy rights, disclaimers, regulations (e.g., Health Insurance Portability and Accountability Act) targeted to be applicable to a patient. A patient who has not accepted the terms and conditions may be prevented from accessing portions, or the entirety, of the information collection and record generation system.

At step 806, after the patient account has been created, the patient may get into contact with a healthcare service provider. In one embodiment, the patient is put into contact with the healthcare service provider, as described herein, upon accepting the session invitation transmitted as part of account creation process.

### Alternative Implementations

The foregoing apparatus and methods may be further utilized to provide other services and service areas.

In one implementation, the methods and apparatus as discussed herein are configured to provide educational services. For example, a teacher may send out session invitations to student join one or more classes. The class may be presented as a recorded lecture or may be provided via live streaming. Students joining the session will be able to take notes on the lecture using the interface. A student may further be able to label and distinguish portions of the notes. For instance, a student may label notes to be relevant to particular subject matter used for later sorting. Furthermore, the student my download the notes in full detail, such as via an email transmitted at the end of the lecture session.

In another implementation, the methods and apparatus as discussed herein are configured to provide auto insurance claim services. A user may be provided a session invitation with a insurance representative. During the session, the user may take video and/or picture recordings of the vehicle in which the user is making a claim. Alternatively, the insurance representative may initiate a session and personally take the recordings of the vehicle associated with the claim. The insurance representative may be able to make and label notes based on the received recordings. A report record of the claim session may be generated upon termination of the session which may be downloaded by the insurance representative or other personal responsible for processing insurance claims.

In yet another implementation, the methods and apparatus as discussed herein are configured to provide home inspection services. Accordingly, a person viewing a data collected from a home inspection may take notes and classify them for use in generating a home inspection report. For example, a home inspector may flag notes based on a level of perceived seriousness to filter between minor home issues to issues requiring major repair.

In even another implementation, the methods and apparatus as discussed herein are configured to provide legal billing services. An attorney and/or client may request for a session, such as a teleconference. During the teleconference, the attorney may make notes and flag issues, in addition to billing codes for subject matter discussed. Accordingly, after the session has concluded, a data record is generated. The generated record may later be view by the attorney for use in the preparation of legal services. Furthermore, the generated record may be downloaded for use in creating invoices to bill clients for services performed.

Lastly, in another implementation, the methods and apparatus as discussed herein are configured to provide web and telephone conferencing services. Accordingly, members invited to a teleconference may take and organize notes. After conclusion of the teleconference, each member of the teleconference may be permitted to download their respective notes. In addition, members may be able to download consolidate notes for the particular meeting. The consolidate notes may be notes for all members of the meeting or may comprise a subsection thereof. For example, consolidate notes may be made for group members based on job function or management level.

### Other Business Considerations

Various other business-related aspects are now described.

In one embodiment, access to the various ones of the above-described features of the reporting system is featured as part of one or more optional subscription plans. For example, access to up-to-date uniform healthcare codes, the user interfaces, and/or host server may be charged at a premium. Additionally, certain features may be provided at additional cost over a basic fee for access to fewer features.

In another example, a user may be charged by an entity associated with the host server on a per-record upload basis. Alternatively, a user may purchase a subscription for access to the services on a multi-record, per-month, and/or per-year basis.

In yet another alternative, users health care premiums are used to subsidize the costs of operating and using the system.

Many other approaches and combinations are envisaged consistent with the disclosure, as will be recognized by those of ordinary skill when provided this disclosure.

It should be recognized that while the foregoing discussion of the various aspects of the disclosure has described specific sequences of steps necessary to perform the methods of the present disclosure, other sequences of steps may be used depending on the particular application. Specifically, additional steps may be added, and other steps deleted as being optional. Furthermore, the order of performance of certain steps may be permuted, and/or performed in parallel with other steps. Hence, the specific methods disclosed herein are merely exemplary of the broader methods of the disclosure.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The described embodiments are to be considered in all respects only illustrative and not restrictive. The scope of the disclosure is, therefore, indicated by the appended claims rather than the foregoing description. All changes that come within the meaning and range of equivalence of the claims are embraced within their scope.

1. A method for generating data records, comprising:
collecting a plurality of data;
identifying one or more regions of interest within said plurality of data;
generating metadata describing said one or more regions of interest within said plurality of data; and
packaging at least portions of said plurality of data comprising said one or more regions of interest with said metadata descriptive thereof.

2. The method of claim 1, wherein said plurality of data is collected at a client apparatus configured to record audio and video data.

3. The method of claim 1, wherein said metadata comprises at least user-entered text configured to describe said one or more regions of interest.

4. The method of claim 1, wherein said metadata comprises at a least user-entered alpha-numeric code, the code correlating to a known classification of information.

5. The method of claim 4, wherein the known classification comprises a substantially standardized medical or health care classification system that specifically identifies one or more medical or health care services provided.

6. The method of claim 1, further comprising:
evaluating said plurality of data to obtain information therefrom; and
comparing said information to a database of reference information.

7. The method of claim 6, wherein said metadata comprises at least an alpha-numeric code automatically selected based at least in part on said acts of evaluating and comparing.

8. The method of claim 1, further comprising transmitting said packaged at least portions of said plurality of data to an entity configured to evaluate said data for adherence to a rule set.

9. The method of claim 8, wherein the rule set comprises a rule set relating to approval or denial of one or more health care services claims for payment.

10. A method of generating healthcare service data records, comprising:
creating a media recording of a healthcare session;
identifying one or more aspects of interest within said media recording;
applying a timestamp to each of said one or more aspects of interest;
for each of said one or more aspects of interest, applying an alpha-numeric code descriptive thereof; and
generating a plurality of data records, of said plurality of data records comprising at least a portion of said media recording, said timestamp, and said alpha-numeric code.

11. The method of claim 10, further comprising transmitting said plurality of data records to a health insurance entity.

12. The method of claim 11, further comprising receiving from said health insurance entity an evaluation of said plurality of data records provided thereto, said evaluation indicating at least one of (i) an amount for payment, and/or (ii) an approval or disapproval of healthcare services.

13. The method of claim 12, further comprising utilizing said received evaluation to generate a bill for payment by said health insurance entity and/or a patient.

14. The method of claim 10, further comprising enabling a user to add additional descriptive text to said plurality of data records.

15. A computer readable apparatus comprising a plurality of computer executable instructions which are configured to, when executed, cause a client electronic device to:
collect a plurality of data;
identify at least one subset of data within said plurality of data;
generate metadata describing said at least one subset within said plurality of data; and
package at least portions of said plurality of data comprising said at least one subset with said metadata descriptive thereof.

16. The computer readable apparatus of claim 15, wherein said plurality of data comprises an audio and/or video recording of a healthcare session.

17. The computer readable apparatus of claim 16, wherein said metadata describing said at least one subset within said plurality of data comprises at least one of:
a timestamp; and/or
an alpha-numeric code descriptive of the at least one subset.

18. The computer readable apparatus of claim 17, wherein said package of said at least portions of said plurality of data comprises at least a portion of said audio and/or video recording, said timestamp, and said alpha-numeric code.

19. The computer readable apparatus of claim 18, wherein said plurality of instructions are further configured to cause said electronic device to transmit said package of said at least portions of said plurality of data to a health insurance entity.

20. The computer readable apparatus of claim 19, wherein said plurality of instructions are further configured to cause said electronic device to:
receive from said health insurance entity an evaluation of said plurality of data records provided thereto, said evaluation indicating an amount for payment and/or an approval or disapproval of healthcare services; and
utilize said received evaluation to generate a bill for payment by said health insurance entity or a patient.

21. The computer readable apparatus of claim 15, wherein said plurality of instructions are further configured to cause said electronic device to display at least a portion of said collected plurality of data on a user interface.

22. The computer readable apparatus of claim 21, wherein said plurality of instructions are further configured to cause said electronic device to enable a user of said electronic device to generate said metadata via said user interface, said metadata comprising descriptive text and/or selection an alpha-numeric code configured to describe said at least one subset within said plurality of data.
